(19) United States
(12) Patent Application Publication
(10) Pub. No.: US 2022/0180573 A1
(43) Pub. Date: Jun. 9, 2022

(54) COMPUTER-IMPLEMENTED METHOD FOR ANALYZING MEASUREMENT DATA OF AN OBJECT

(71) Applicant: Volume Graphics GmbH, Heidelberg (DE)

(72) Inventors: Johannes FIERES, Heidelberg (DE); Gerd SCHWADERER, Heidelberg (DE); Thomas GÜNTHER, Heidelberg (DE); Matthias FLESSNER, Heidelberg (DE); Markus RHEIN, Heidelberg (DE)

(21) Appl. No.: 17/598,821

(22) PCT Filed: Mar. 26, 2020
(86) PCT No.: PCT/EP2020/058551

§ 371 Date: Sep. 27, 2021

(30) Foreign Application Priority Data
Mar. 27, 2019 (DE) 10 2019 107 952.7

(51) Int. Cl. G06T 11/00; G06T 3/00; G06T 7/70

(52) U.S. Cl. CPC G06T 11/003; G06T 7/70; G06T 3/0031

(57) ABSTRACT

Described is a computer-implemented method for analysing measurement data of an object, said measurement data defining an object representation in a measurement coordinate system, wherein the method comprises the following steps: determining the measurement data of the object; providing an object coordinate system for at least one part of the object; providing an evaluation specification for the analysis, wherein the evaluation specification determines at least one set of coordinates from the provided object coordinate system for performing the analysis; determining a non-solid mapping between the provided object coordinate system and the object representation; and determining, by means of said non-solid mapping, at least one partial region of the measurement data for the analysis to be performed. Thus, the invention provides an improved computer-implemented method for analysing measurement data of an object, wherein the method prevents the analysis results from being distorted due to deformations of the object.

The invention relates to a computer-implemented method for analysing measurement data of an object according to the preamble of claim 1.

For the analysis, e.g. a dimensional measurement, of objects such as workpieces, area-based or volumetric measurement data of the object to be measured and its surface can be acquired. For example, a measurement can be carried out by means of computer tomography. The measurement data is initially available in the device coordinate system, which is based on the orientation and the position, the so-called pose, in which the measured object is located in relation to the measuring device at the time of the measurement. However, a dimensional measurement requires clearly defined coordinates of the object. These coordinates are defined in the workpiece coordinate system of the object and can be specified by the technical drawing of the object or an evaluation plan. The workpiece coordinate system is defined on the object itself, i.e. on the geometries and geometry elements of the object itself, and is thus independent of its orientation or position in space. In order to perform the measurements at the defined coordinates of the object, the device coordinate system and the workpiece coordinate system must therefore be aligned to each other.

It is known to measure a sufficient number of geometry elements on the object and use them for the alignment. Another known alternative is to use a virtual model of the object that is already aligned in the workpiece coordinate system. The measurement data can then be aligned to the virtual model using a suitable algorithm, e.g. a best-fit algorithm, so that the data is then available in the workpiece coordinate system.

It is also known to perform the analyses, such as the dimensional measurements, by means of sample measurement plans, wherein the sample measurement plans can be based on an ideal geometry of the object or on a randomly selected reference measurement of the object. Small deviations of the measured objects from the geometry underlying the sample measurement plan, such as minor manufacturing deviations, can be measured in a stable manner because the sampling points on the geometry elements for dimensional measurement are searched for in the environment of the defined geometry element. A sampling point in this case is a measuring point that has been identified on the surface and can be used for further evaluation. In case of major deviations between the geometry of the object to be measured and the geometry underlying the sample measurement plan, it is possible that at least some of the sampling points will not be set correctly. This distorts the result of the dimensional measurement.

The object of the invention is therefore to provide an improved computer-implemented method for analysing measurement data of an object.

The main features of the invention are specified in claims 1 and 15. Embodiments are the subject of claims 2 to 14 and the following description.

To achieve the object, a computer-implemented method for analysing measurement data of an object is provided, wherein the measurement data defines an object representation in a measurement coordinate system, the method comprising the following steps: determining the measurement data of the object; providing an object coordinate system for at least one part of the object; providing an evaluation specification for the analysis, wherein the evaluation specification defines at least one coordinate set from the provided object coordinate system for carrying out the analysis; determining a non-rigid mapping between the provided object coordinate system and the object representation; and determining, by means of the non-rigid mapping, at least one subregion of the measurement data for the analysis to be carried out.

According to the invention, before the analysis of the measurement data, which may be, but is not limited to, e.g. a dimensional measurement, the largely global deformation between the target geometry and the measured actual geometry of at least one part of the object is determined. The target geometry is based on an object coordinate system on which the information in the evaluation specification is based. The object coordinate system defines the pose, i.e. the position and orientation of the object in space, based on a part of the surface or the entire surface of an object. For example, the object coordinate system can be defined by a CAD model. The actual geometry of the object to be analyzed based on the measurement data is based on the measurement coordinate system in which the object representation is defined. The object representation can be, for example, a digital object representation. The measurement data can be determined by means of a computer tomography measurement.

The result of the detected global deformation is a deformation field, or a non-rigid mapping. In contrast to a dimensionally-fixed or rigid mapping, which is composed of transformations and rotations of the overall representation of an object, the non-dimensionally-fixed or nonrigid mapping takes into account local deformations. By means of the non-rigid mapping, the target geometry and the actual geometry can be approximately deformed into each other. Thus, the regions to be analyzed from the target geometry, which are defined by the at least one coordinate set of the evaluation specification, are deformed into the actual geometry of the object to be examined by means of the non-rigid mapping. This allows the subregion of the measurement data to be determined, in which the measurements or analyses must be applied to the measurement data in order to be able to carry them out. This prevents irrelevant or incorrect regions of the object or regions outside the object from being measured or analyzed due to a deformation of the object to be measured.

This is particularly useful for analyses performed on flexible or deformable objects, wherein, for example, these objects have a different geometry in their installed state than in their disassembled state. This can relate, for example, to objects made of flexible or elastic materials and/or thin-walled structures, as well as the first objects produced by tools or the products of new, not yet optimized production methods, such as 3D printing. Examples of objects are thin metal sheets or lamellar-like structures, such as plastic plugs. Furthermore, severe deformations can also be caused by inhomogeneous cooling, large tolerances in manufacture, or defective or old machines. Due to the non-rigid mapping between the object coordinate system and the measurement coordinate system, flexible or deformable objects can be measured in a non-deformed or deformed state. Mapping of the object coordinate system onto the object representation based on the measurement coordinate system using the non-rigid mapping can result in a virtual clamping or deformation of the measured object into a deformed installed state, or reference state, in which the at least one coordinate set of the evaluation specification is defined. This enables a correct measurement or analysis. This also prevents the objects to be measured from having to be physically clamped or deformed in order to determine the measurement data.

The sequence of the steps described above and listed below can be changed as required, provided the interdependencies between the individual steps are taken into account. Furthermore, the steps can be executed simultaneously, taking into account their interdependencies.

In addition, the method may comprise the following step: identifying a three-dimensional region in the object representation, wherein the identified three-dimensional region corresponds to the at least one coordinate set mapped onto the object representation by means of the nonrigid mapping. This step can be carried out, for example, to determine at least one subregion of the measurement data in which the analysis is required.

The evaluation specification thus comprises a coordinate set that defines a three-dimensional region in which an analysis is to be performed. This can be, for example, an analysis of the volume inside the component with regard to defects. By means of the non-rigid mapping, the corresponding three-dimensional region in the measurement data is now identified. This may also mean that the shape of the three-dimensional region changes, since the mapping is a non-rigid one. For example, as a result of the mapping a cuboid-shaped three-dimensional region can become a deformed cuboid with curved edges and surfaces. This means that directions required for measurements or analyses can also be transformed in a locally resolved manner, e.g. a measurement of fiber lengths in a specific projection direction in the case of a fiber composite analysis.

For example, the provision of an object coordinate system of at least one part of the object may comprise the following substep: deriving the object coordinate system from the evaluation specification.

This allows the object coordinate system to be derived directly from the regions designated by the evaluation specification, in which the analysis of the measurement data is to be carried out. For example, the evaluation specification can be derived from the analyses to be performed without the entire geometry of the object needing to be known.

The non-rigid mapping can also comprise at least one rigid mapping to map at least one element of the object coordinate system onto the object representation.

For example, if elements of the object coordinate system are subject to only a small deformation, the non-rigid mapping can be simplified by means of the rigid mapping. The non-rigid mapping may also comprise rigid mappings only in certain sections. The sections between the rigid mappings can be determined by interpolation, for example.

In another example, the object coordinate system may comprise coordinates defined as control points, wherein the determination of the non-rigid mapping comprises the substeps: determining mappings of control point positions from the object coordinate system into the object representation; and determining the non-rigid mapping by means of the mappings of the control point positions from the object coordinate system into the object representation; wherein a density of the control points in at least one region of the object coordinate system, which is mapped onto at least one surface of the object representation by the mapping, is higher than in a region that is mapped outside of the at least one surface of the object representation.

The term “on a surface” here is defined as described above and is not limited to the case where the control points must lie directly on the surface. They can also be located in the vicinity of the surface. The control points are used to define the accuracy or resolution of the non-rigid mapping locally. On surfaces of the object representation that require a high accuracy of the nonrigid mapping, because analyses are to be performed in these regions, the control points have a higher density than in regions that are not relevant to the analyses. This reduces the total number of control points. This can also reduce the time required to determine the non-rigid mapping.

Alternatively, the control points can also be arranged in a regular pattern, for example, so that they form a grid.

For example, the object coordinate system can also have coordinates that are defined as control points, wherein determining the non-rigid mapping comprises the substeps: determining mappings of control point positions from the object coordinate system into the object representation; and determining the non-rigid mapping by means of the mappings of the control point positions from the object coordinate system into the object representation; repeating the substeps of determining mappings of control point positions from the object coordinate system into the object representation and determining the non-rigid mapping by means of the mappings of the control point positions from the object coordinate system in the object representation with a higher number of control points until a deviation between a mapped representation on the one hand, determined from the object coordinate system by means of the non-rigid mapping, and the object representation on the other, is within a predefined deviation range.

In this way, the number of control points will be changed from a coarse resolution to a fine resolution. For example, a few control points are used initially to enable a rough assignment of the mutually corresponding geometries. Gradually, the number of control points is increased to allow for smaller geometries in the non-rigid mapping also. This ensures that the non-rigid mapping converges to the best solution. A similar procedure can be used in an analytical description of the mapping by successively increasing the number of terms taken into account in a Fourier series, for example.

The repetition of the substeps with a higher number of control points may comprise the sub-substeps: determining the regions in which a deviation between the mapped representation and the object representation is outside the predefined deviation range; and increasing the number of control points in parts of the object coordinate system that correspond to the determined regions.

This increases the number of control points only in the regions where a higher number of control points is required. This is determined using the predefined deviation ranges. The deviation ranges used can define how closely the non-rigid mapping should be approximated to the measurement data. This allows a targeted change in the number of control points and reduces the overall number of control points to a minimum.

The method may also comprise the following step before the determination of the non-rigid mapping: providing a predefined minimum threshold value for a size of a region of the object coordinate system to be mapped onto the object representation by means of the non-rigid mapping; wherein the determination of the non-rigid mapping comprises the substep: determining a nonrigid mapping onto the object representation for at least one region of the object coordinate system to be mapped, the size of which is equal to and/or greater than the predefined minimum threshold value.

This can be used to influence the minimum order of magnitude or maximum spatial frequency, which are represented by the predefined minimum threshold value, up to which attempts are made to correct deviations between the mapped object coordinate system and the measurement coordinate system in determining the non-rigid mapping. For example, a density of control points can be locally varied. This can be useful, for example, if certain spatial frequency ranges are to be taken into account later as a deviation in the measurement. This can be the case, for example, in the measurement of roughness and ripple values which must be considered separately from shape deviations.

Alternatively, the order of magnitude can also be selected in such a way that shape deviations in the measurement data up to this value are not “corrected” in the mapping. For example, a cut-off frequency of the spatial frequency can be defined as a limit. This can also be used to prevent direction vectors from being incorrectly mapped due to local over-adjustments. Control points can only be considered up to a corresponding resolution.

The predefined minimum threshold value can be provided, for example, by the evaluation specification or by a user.

Further, the determination of the non-rigid mapping may comprise the substep: determining a deformation of the object representation by means of a simulated external mechanical force when determining the non-rigid mapping.

This can be used, for example, to simulate a virtual clamping in order to determine the parameters of the non-rigid mapping. In this case, corresponding forces or constraints of a specified clamping of the object or from the application case for the object are simulated together with the resulting deformations of the component. It is also possible to take into account boundary conditions, for example, that an arc length of a distance between points along the surface of an object remains as constant as possible. This assists in ensuring that the simulation of the external mechanical force determines a realistic deformation. This can be performed alternatively or in addition to an optimization of the non-rigid mapping using iterative methods.

The determination of at least one subregion of the measurement data for the analysis to be performed using the non-rigid mapping can comprise the substeps: determining at least one position of a sampling point in the object coordinate system by means of the evaluation specification; mapping the at least one determined position onto the object representation by means of the nonrigid mapping; and determining a sampling point for the analysis in the object representation based on the mapped position.

In the vicinity of the mapped position determined, the corresponding measurement data is searched for in order to determine the sampling point in the object representation for the analysis. For each sampling point from the object coordinate system, a corresponding sampling point in the measurement coordinate system, i.e. from the object representation, is sought based on the mapped position. For example, the search can be based on search radii, search beams, or search cones that define search regions.

In this case, the determination of a sampling point in the object representation can comprise the following sub-substep according to one example: determining a change of search regions and a change in the orientation of the search regions when mapping the object coordinate system onto the object representation.

For example, it is thus possible to take account of the fact that the orientation of the search cones and search beams can vary locally due to the non-rigid mapping. For example, rotations of the search regions between the object coordinate system and the measurement coordinate system can be taken into account.

The coordinate set can also comprise coordinates of at least one complete sub-element of the object, wherein the determination of at least one subregion of the measurement data for the analysis to be performed comprise the substeps: mapping the at least one complete sub-element from the object coordinate system onto the object representation; determining a change in the orientation of the sub-element between the object coordinate system and the object representation; and determining sampling points based on the mapped sub-element and the changed orientation.

A complete geometry element is mapped as a sub-element of the object onto the measurement data, i.e. the object representation, also taking into account the change in the orientation of the geometry element. On the basis of the mapped geometry element, the sampling points on the measurement data are identified. The change in the orientation is described by a translation and a rotation and thus by a dimensionally fixed or rigid mapping for the entire element. The mapped subelement thus acts as a reference point for the determination of the sampling points in the measurement data.

Furthermore, the coordinate set can comprise coordinates of at least two sub-elements of the object, wherein mapping the object coordinate system onto the object representation comprises the substeps: mapping at least two sub-elements of the object from the object coordinate system onto the object representation; determining a change in the orientation of the at least two subelements as a group between the object coordinate system and the object representation; and determining sampling points based on the mapped sub-elements and the changed orientation.

In this way, a plurality of partial elements of the object are mapped from the object coordinate system onto the measurement data in their entirety. This takes into account the change in the orientation of the group. On the basis of the mapped geometry element, the sampling points on the measurement data are identified. Again, this example the change in the orientation is described by a translation and a rotation, and thus a dimensionally fixed or rigid mapping for the at least two elements. In this example, the group of mapped sub-elements acts as a reference point for determining the sampling points in the measurement data.

Another means of achieving the object is provided by a computer program product having instructions that can be executed on a computer, which when executed on a computer cause the computer to carry out the method according to the description given above.

The resulting advantages and extensions of the computer program product are similar to the advantages and extensions of the computer-implemented method described above. Therefore, in this respect, reference is made to the above description.

Further features, details and advantages of the invention are derived from the wording of the claims and from the following description of exemplary embodiments on the basis of the drawings. In the drawings:

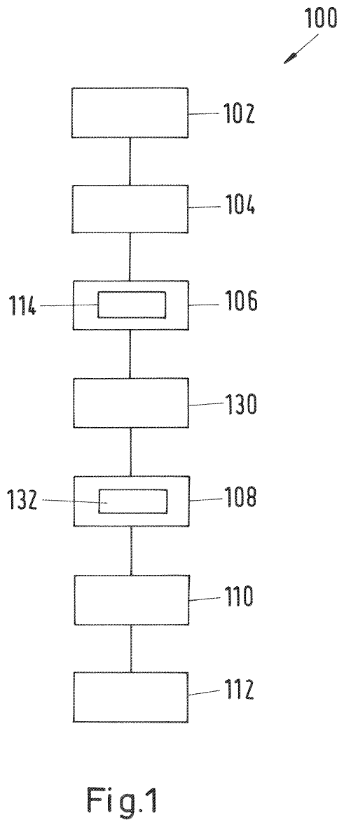

FIG. 1 shows a flowchart of the computer-implemented method,

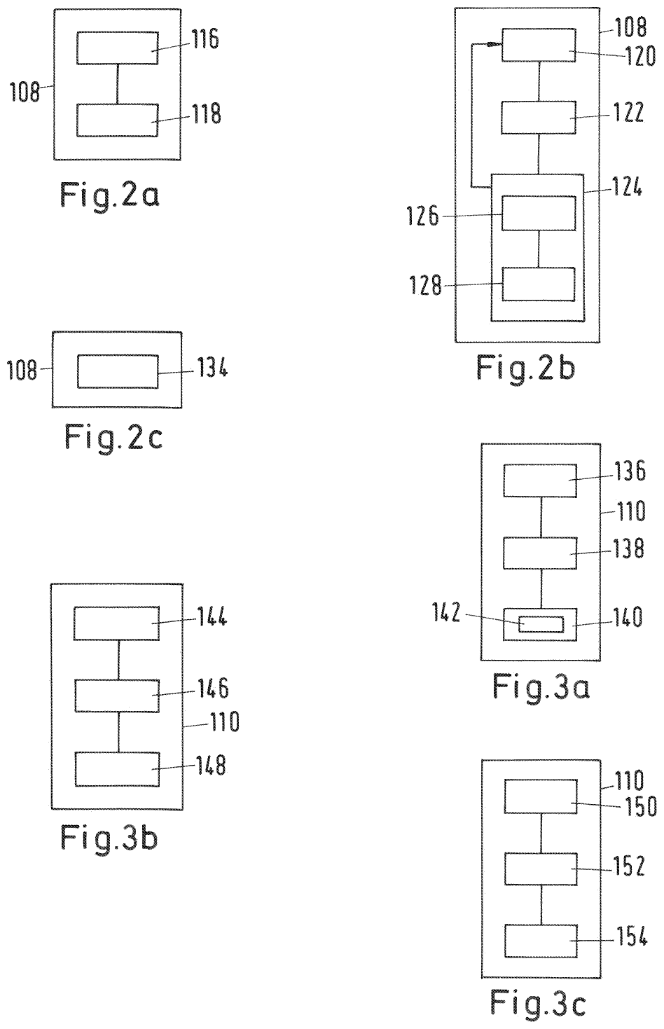

FIG. 2a-c show flowcharts of various examples of the step of determining a non-rigid mapping,

FIG. 3a-c show flowcharts of various examples of the step of mapping the object coordinate system onto the object representation using the non-rigid mapping

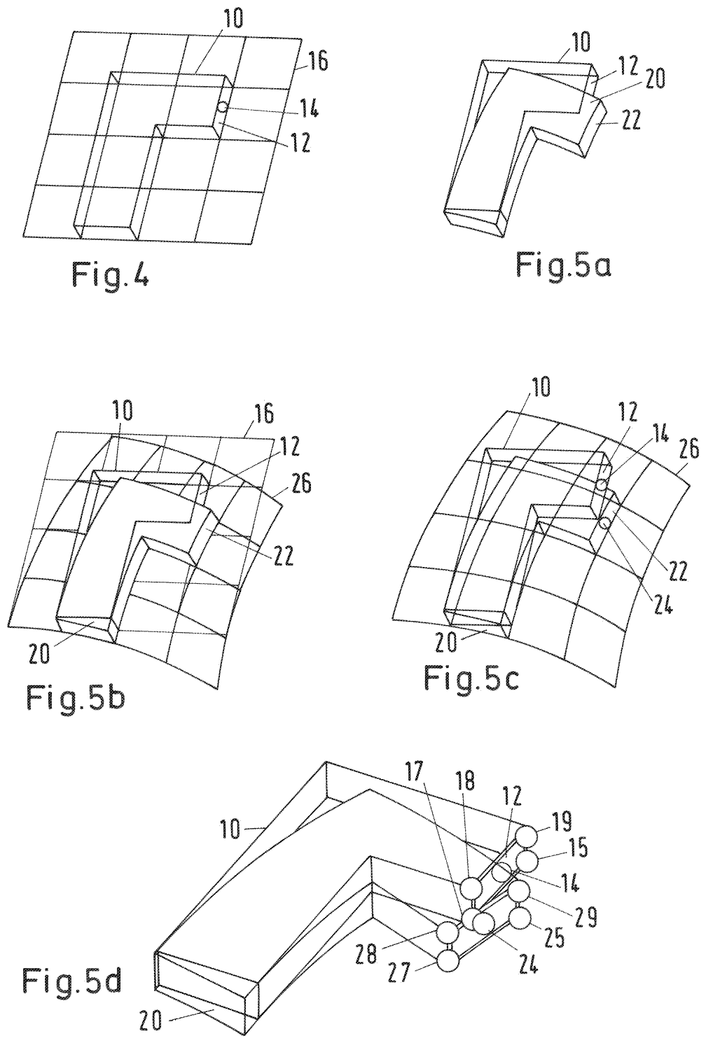

FIG. 4 shows a schematic illustration of an object in an object coordinate system, and

FIG. 5a-d show schematic illustrations of the object in the object coordinate system and an object representation.

FIG. 1 shows a flowchart of a computer-implemented method 100 for analysing measurement data of an object. The object can be a workpiece, in which case the analysis performs a dimensional measurement of the workpiece. The analysis is carried out using the measurement data and is not carried out on the object to be analyzed itself.

Furthermore, an analysis can be carried out for defects, for example, such as inclusions, pores, porosity, loosening of joints, or cracks. Furthermore, an analysis of fiber composite materials can be carried out, e.g. with regard to diameter, length or volume content of fibers, delaminations or matrix fractures. Foam structures and/or wall thicknesses in certain volume regions can also be analyzed. Furthermore, a simulation of the mechanical properties of the object can be investigated, e.g. the deformation of the geometry under stress or the local mechanical load as a von Mises comparative stress. In addition, regions must be defined at which the physical forces act. Furthermore, the analysis can comprise a simulation of physical phenomena, e.g. transport phenomena such as electrical conductivity or absolute permeability.

In a step 102, the measurement data of the object is first determined. The measurement data defines an object representation in a measurement coordinate system, i.e. the coordinates of the object representation are given in the measurement coordinate system. The measurement coordinate system is the coordinate system of the measuring device with which the measurement data is determined. The coordinates in the measurement coordinate system describe the object in the measuring device in an unknown alignment and orientation.

The measurement data can be determined, for example, by means of a computer tomography measurement. The object representation can be a digital object representation and is determined on the basis of the measurement data. A two-dimensional or three-dimensional object representation can be provided. Furthermore, the object representation can be formed from a plurality of image information items, wherein the image information represents the measurement data in a computer tomography measurement of the object as gray-scale values.

In other examples of volumetric measurement data, the measurement data can be determined by means of laminography or tomosynthesis, by means of MRI, by ultrasound or by sonography, by optical coherence tomography or by lock-in thermography. In addition, surface-based measurement data can be used, which can be determined from structured light projection or photogrammetry, for example. Measurement data can also be obtained from light-section methods, from a tactile scanning in scanning mode, or from a tactile scanning in single-point mode.

In a further step 104, an object coordinate system is provided for at least one part of the object. The object coordinate system is defined on the basis of a fixed reference point and three spatial directions on the object itself. The coordinates of the object coordinate system are therefore defined in relation to the object itself and describe the parts of the object relative to the fixed reference point.

The object coordinate system can be derived on the basis of a CAD drawing, for example. Alternatively, the object coordinate system can be derived from a single measured geometry or from a plurality of measured geometries of an object. Alternatively or additionally, the object coordinate system can be derived from measurements of geometries of various similar objects.

In a step 106, an evaluation specification is provided for the analysis. The evaluation specification determines at least one coordinate set from the object coordinate system provided for performing the analysis. This means that the evaluation specification defines a part of the object in the object coordinate system by means of the coordinates of the part of the object on which the analysis is to be performed using the computer-implemented method 100.

The steps 104 and 106 can be performed simultaneously, wherein the object coordinate system is derived from the evaluation specification in a substep 114 of step 106. In this case, the evaluation specification comprises information about parts of the object from which the object coordinate system can be derived.

Optionally, in a step that is not shown, a preliminary rigid mapping can be determined between the object coordinate system and the measurement coordinate system. This provides an initial, rough assignment of the object coordinate system onto the object representation. Using the initial rough mapping by the provisional rigid mapping, in some cases the non-rigid mapping can be determined faster and more accurately.

The method 100 comprises a further step 108, in which a non-rigid mapping is determined between the provided object coordinate system and the object representation. This means that a mapping is sought which maps the object coordinate system onto the measurement coordinate system and/or vice versa. In the following, only the example in which the object coordinate system is mapped onto the measurement coordinate system is explained. The following explanations apply analogously to the mapping of the measurement coordinate system onto the object coordinate system.

Since the object representation is formed from a measurement of a real object, the object representation may be deformed with respect to the object on which the object coordinate system is based. The non-rigid mapping maps the coordinates of the object coordinate system onto the measurement coordinate system in such a way that the distances and angular relations between the coordinates of the object coordinate system can be changed by the mapping. The non-rigid mapping can thus be used to map a deformation of the object.

The non-rigid mapping can then comprise at least one rigid mapping, which maps at least one element of the object coordinate system onto the measurement coordinate system in a rigid manner.

Furthermore, the non-rigid mapping, which is position-dependent, can be described globally and thus analytically for the entire three-dimensional space under consideration. This can be carried out using a Fourier series, for example.

In an alternative example, by means of or instead of the non-rigid mapping, an inverse mapping can be determined, which maps the measurement coordinate system onto the object coordinate system. In this case the analysis can be carried out on the mapped measurement data.

In a further step 110, at least one subregion of the measurement data in which the analysis is to be performed is determined by means of the non-rigid mapping. The object coordinate system can be mapped onto the object representation, i.e. onto the measurement coordinate system, by means of the non-rigid mapping. This allows the coordinate set provided by the evaluation specification to be mapped from the object coordinate system onto the measurement coordinate system. This means a subregion of the measurement data can be determined in which the analysis is to be performed.

In a first exemplary embodiment, before step 108, the method 100 can comprise the step 130 in which a predefined minimum threshold value is provided for the size of a region of the object coordinate system to be mapped onto the object representation by means of the non-rigid mapping. This defines a minimum size for the regions of the object coordinate system to be mapped onto the object representation. The regions mapped by the non-rigid mapping must therefore be larger than the predefined minimum threshold value. For this purpose, in a substep 132 of step 108 a non-rigid mapping is determined for at least one region of the object coordinate system to be mapped onto the object representation, the size of which is equal to and/or greater than the predefined minimum threshold value. This can be used to influence the minimum order of magnitude or maximum spatial frequency, which are represented by the predefined minimum threshold value, up to which the non-rigid mapping attempts to correct deviations between the mapped object coordinate system and the measurement coordinate system.

In addition, the method 100 comprises the step 112, in which a three-dimensional region is identified in the object representation, wherein the identified three-dimensional region corresponds to the at least one coordinate set mapped onto the object representation by means of the nonrigid mapping.

A geometry element which was mapped using the non-rigid mapping can be fitted to the measurement data, for example, using a least-squares fit or a minimum-zone fit. The analyses can then be performed on the fitted geometry element. Preferably, a dimensional measurement is performed as an analysis.

Alternatively or additionally, specific regions of the surface can be analyzed with regard to different properties. Thus, an analysis of surface parameters such as ripple and roughness can be performed in defined regions. Furthermore, for the analysis of the local deviation of the geometry from the nominal geometry, a target-actual comparison or a wall thickness analysis can be performed. However, the analysis regions on surfaces can also be implicitly defined over volume regions.

It is also possible to define certain regions of interest (ROI) as surface or volume regions which are processed separately. For example, these measurement data from these regions can be stored and thus archived or submitted to an operator for a manual inspection.

The method 100 can comprise alternative exemplary embodiments. FIGS. 2a to 2c show alternative exemplary embodiments in which step 108 is alternatively implemented. FIGS. 2a to 2c should be understood in such a way that step 108 is carried out as part of the method 100.

FIG. 2a shows an exemplary embodiment of step 108, in which the determination of the non-rigid mapping comprises the substeps 116 and 118. The object coordinate system in this case has coordinates that are defined as control points. A density of the control points arranged on the object in the object coordinate system in the vicinity of at least one surface may be higher than a density of the control points arranged in the object coordinate system outside of the at least one surface. At the same time, this means that the density of the control points that are mapped into the vicinity of at least one surface of the object representation by the mapping is higher than in a region that is mapped outside of the at least one surface of the object representation. This means that a surface of the object can comprise more control points than a region that does not represent a surface. The control points are thus arranged in an irregular grid. In sub-step 116, mappings of control point positions are obtained from the object coordinate system into the object representation. Further, in step 118, the non-rigid mapping is determined using the mappings of the position of the control points.

A mapping of individual points defined as control points from the object coordinate system into the measurement coordinate system is first determined. Based on these mappings, a nonrigid mapping is then determined to map other points that are not defined as control points from the object coordinate system onto the measurement coordinate system.

Another exemplary embodiment of step 108 is shown in FIG. 2b. Again, in this exemplary embodiment, the object coordinate system has coordinates defined as control points. The control points can be located in a regular or irregular grid. Step 108 comprises the substeps 120, 122 and 124.

In substep 120, mappings of the positions of the control points from the object coordinate system into the object representation are determined. In substep 122, these mappings of the positions of the control points from the object coordinate system into the object representation are used to determine the non-rigid mapping. Steps 120 and 122 are repeated by step 124 with a higher number of control points in the object coordinate system. Increasing the number of control points can involve, for example, an increase in the density of the control points. Alternatively or in addition, the number of control points can be increased by defining control points in regions of the object where no control points were previously arranged.

Steps 120 and 122 are repeated until a deviation between a mapped representation on the one hand, determined from the object coordinate system by means of the non-rigid mapping, and the object representation on the other, is within a predefined deviation range. This means that the number of control points for which mappings from the object coordinate system into the object representation are sought is increased until the resulting non-rigid mapping maps the object coordinate system onto the measurement coordinate system within predefined limits defined by the deviation range. The repetition thus increases the accuracy of the non-rigid mapping.

In this case, the sub-step 124 may comprise the sub-substeps 126 and 127.

In step 126, the regions are determined in which a deviation between the mapped representation and the object representation is outside the predefined deviation range. In other words, it is determined where exactly the non-rigid mapping produces a mapped representation that deviates from the object representation from the object coordinate system.

In addition, in step 128 the number of control points is increased in the parts of the object coordinate system where the mapped representation of the object representation is outside the predefined deviation range. In other words, new control points are set in the regions in which the non-rigid mapping performs a mapped representation onto the measurement coordinate system outside the deviation range. Increasing the control points in these regions will result in more mappings of the control point positions from these regions from the object coordinate system into the measurement coordinate system being determined for each repetition. Due to the larger number of mappings of the control point positions in these regions, it is possible to determine a more accurate non-rigid mapping for mapping the object coordinate system into the measurement coordinate system.

FIG. 2c shows a further alternative embodiment of the method 100 with the step 108. Step 108 comprises the substep 134, in which a deformation of the object representation is determined by means of a simulated external mechanical force when determining the non-rigid mapping.

The object representation in the measurement coordinate system is thus virtually deformed by means of simulated external mechanical forces in order to bring the measured object virtually into a shape corresponding to the object on which the coordinate system is based. In particular in the case of flexible objects, which have a different shape when in the usage state than during their production, this allows the usage state of the measured object to be simulated by means of the simulation. This allows the non-rigid mapping to be defined on the basis of the deformations determined from the simulated forces. Based on the deformation calculated in this way, the non-rigid mapping of the object coordinate system onto the object representation can still be calculated.

In another alternative version of step 108 that is not shown, for example, the performance of a global scaling of the object for mapping the object coordinate system onto the measured data can be restricted or sanctioned. This avoids unwanted application of a global scaling which may be unrealistic for the mapping.

The further FIGS. 3a to 3c show further exemplary embodiments of the method 100, which differ in step 110. It is understood that these exemplary embodiments can be combined with the exemplary embodiments of the method according to the description given above.

According to the exemplary embodiment from FIG. 3a, the mapping of the object coordinate system onto the object representation by means of the non-rigid mapping is carried out using the substeps 136, 138 and 140.

Step 136 comprises the determination of at least one position of a sampling point in the object coordinate system by means of the evaluation specification. The position of the sampling point is mapped onto the object representation in step 138 by means of the non-rigid mapping. Then, in step 140, a sampling point for the analysis of the measurement data in the object representation is determined based on the mapped position. The sampling point for the analysis of the measurement data in the object representation can be determined by searching for corresponding measurement data, for example of a surface, in the vicinity of the mapped position that was determined. For example, the search can be based on search radii, search beams, or search cones that define search regions.

Sub-step 140 can also comprise the sub-substep 142, in which a change of search regions when mapping the object coordinate system onto the object representation is determined. A change in search regions can occur, for example, if the orientation of the search region, for example a search beam or a search cone, is changed. Likewise, the shape of the search region during the mapping may change. By taking these changes into account, the determination of the sampling point for the analysis can be carried out with increased accuracy on the basis of the determined position of the sampling point in the object coordinate system.

For example, a geometry element of the object can be fitted to the determined sampling points. Additional sampling points can be determined using the fitted geometry element. In this manner, that sampling points can be determined that are better fitted to the geometry elements and make it simpler to perform the analysis. In addition, this allows reproducible results to be obtained.

If the object is defined on a CAD model, for example CAD surfaces or CAD elements, corner points or corner line, U-V line or control points of CAD surfaces or CAD elements, the deformations in the object representation can be applied to the CAD model to derive the mapping of the geometry elements indirectly via the mapping of the CAD model.

In a further exemplary embodiment of the method 100, step 110 comprises the substeps 144, 146 and 148, as shown in FIG. 3b. In this exemplary embodiment, the coordinate set comprises coordinates of at least one complete sub-element of the object. This means that the coordinate set, which is defined by the evaluation specification, defines at least one contiguous surface in the object coordinate system.

In sub-step 144, the at least one complete sub-element from the object coordinate system is mapped onto the object representation. The mapping is performed with the non-rigid mapping. Thereafter, in substep 146, a change in the orientation of the sub-element is determined from a comparison between the object coordinate system and the measurement coordinate system. For example, the sub-element may be subject to rotation when it is mapped from the object coordinate system into the measurement coordinate system. In substep 148, sampling points are then determined on the basis of the mapped complete sub-element and the changed orientation. The sampling points are used for the analysis of the measurement data in the object representation.

A further exemplary embodiment of the method 100 is shown in FIG. 3c. Here, the coordinate set comprises coordinates of at least two sub-elements of the object. Step 110 comprises the substeps 150, 152 and 154.

In sub-step 150, the at least two sub-elements of the object are mapped from the object coordinate system onto the measurement coordinate system, i.e. into the object representation. Further, in substep 152, the changes in the orientations of the at least two sub-elements between the object coordinate system and the object representation are determined as a group. This does not take into account the changes in the individual orientations of the two sub-elements, but rather the change in the orientation of the group of the two sub-elements. This means that, for example, the two sub-elements can have slightly different orientations relative to each other after the mapping, although the overall alignment of the two sub-elements has not changed. In another example, the orientation of the two sub-elements relative to each other may not have changed, whereas the overall orientation of the two elements has changed. The two mappings of the sub-elements and the changed orientation are taken into account in step 154 in order to determine sampling points.

FIG. 4 shows an example of an object 10 in a reference state. By way of example the object 10 is shown as a corner, but in fact it can have any shape. The object 10 is defined in an object coordinate system 16. Furthermore, the object 10 comprises a surface 12 on which a sampling point 14 is illustrated.

FIG. 5a shows the object 10 and an object representation 20, which is derived from the measurement data. The object representation 20 is deformed compared to the object 10, which is in the reference state. The surface 22 of the object representation 20 corresponds to the surface 12 of the object 10 in the reference state.

FIG. 5b shows that the object coordinate system 12 is mapped into the measurement coordinate system by means of a non-rigid mapping. The non-rigid mapping in this case is a deformation field, which comprises for each coordinate from the object coordinate system 12 the information about the movement in space which a coordinate would have to make in order to land on the corresponding geometry in the measurement coordinate system. The object coordinate system 12 is mapped into the measurement coordinate system as coordinate system 22. For simplification purposes, only a two-dimensional deformation field is illustrated. However, this does not exclude the possibility that the non-rigid mapping may have a three-dimensional deformation field.

According to FIG. 5c, the position of the sampling point 14 in the measurement coordinate system is determined. Since the determined position of the sampling point 14 in the measurement coordinate system does not always correspond exactly to the desired position of the sampling point 14 on the surface in the object coordinate system 16, despite the non-rigid mapping, in the vicinity of the position determined in the measurement coordinate system, the position for a sampling point 24 at the correct corresponding position in the measurement coordinate system is searched for. According to FIG. 5D, a position in the object representation can be determined for a plurality of sampling points 14, 15, 17, 18, 19 in order to set the sampling points 24, 25, 27, 28, 29, in the object representation for the analysis of the measurement data. The plurality of sampling points 24, 25, 27, 28, 29 can be used, for example, to define and analyze surface elements.

The computer-implemented method 100 can be executed on a computer using a computer program product. The computer program product comprises instructions that can be executed on a computer. When these instructions are executed on a computer, they cause the computer to carry out the method.

The invention is not limited to any one of the embodiments described above but can be varied in many ways. All the features and advantages arising from the claims, the description and the drawing, including design details, spatial arrangements and method steps, may be essential to the invention both taken individually and in a wide variety of combinations.

### LIST OF REFERENCE SIGNS

10 object
12 surface
14 sampling point
15 sampling point
16 object coordinate system
17 sampling point
18 sampling point
19 sampling point
20 object representation
22 surface
24 sampling point
25 sampling point
26 mapped coordinate system
27 sampling point
28 sampling point
29 sampling point

1. A computer-implemented method for analysing measurement data of an object, wherein the measurement data defines an object representation in a measurement coordinate system, the method comprising the following steps:
determining the measurement data of the object;
providing an object coordinate system for at least one part of the object;
providing an evaluation specification for the analysis, wherein the evaluation specification determines at least one set of coordinates from the provided object coordinate system for performing the analysis;
determining a non-rigid mapping between the provided object coordinate system and the object representation; and
determining, by means of said non-rigid mapping, at least one partial region of the measurement data for the analysis to be performed.

2. The computer-implemented method as claimed in claim 1, wherein the measurement data is determined by means of a computer tomography measurement.

3. The computer-implemented method as claimed in claim 1, wherein the method also comprises the following step:
identifying a three-dimensional region in the object representation, wherein the identified three-dimensional region corresponds to the at least one coordinate set mapped onto the object representation by means of the non-rigid mapping.

4. The computer-implemented method as claimed in claim 1, wherein the provision of an object coordinate system of at least one part of the object comprises the following substep:
deriving the object coordinate system from the evaluation specification.

5. The computer-implemented method as claimed in claim 1, wherein the non-rigid mapping comprises at least one rigid mapping for mapping at least one element of the object coordinate system onto the object representation.

6. The computer-implemented method as claimed in claim 1, wherein the object coordinate system comprises coordinates defined as control points, wherein the determination of the non-rigid mapping comprises the substeps:
determining mappings of control point positions from the object coordinate system into the object representation; and
determining the non-rigid mapping by means of the mappings of the control point positions from the object coordinate system into the object representation;
wherein a density of the control points in at least one region of the object coordinate system, which is mapped onto at least one surface of the object representation by the mapping, is higher than in a region that is mapped outside of the at least one surface of the object representation.

7. The computer-implemented method as claimed in claim 1, wherein the object coordinate system comprises coordinates defined as control points, wherein the determination of the non-rigid mapping comprises the substeps:
determining mappings of control point positions from the object coordinate system into the object representation; and
determining the non-rigid mapping by means of the mappings of the control point positions from the object coordinate system into the object representation;
repeating the substeps of determining mappings of control point positions from the object coordinate system into the object representation and determining the non-rigid mapping by means of the mappings of the control point positions from the object coordinate system in the object representation with a higher number of control points until a deviation between a mapped representation on the one hand, determined from the object coordinate system by means of the non-rigid mapping, and the object representation on the other, is within a predefined deviation range.

8. The computer-implemented method as claimed in claim 7, wherein the repetition of the substeps with a higher number of control points comprises the sub-substeps:
determining the regions in which a deviation between the mapped representation and the object representation is outside the predefined deviation range; and
increasing the number of control points in parts of the object coordinate system that correspond to the determined regions.

9. The computer-implemented method as claimed in claim 1, wherein before the determination of the non-rigid mapping the method comprises the step:
providing a predefined minimum threshold value for a size of a region of the object coordinate system to be mapped onto the object representation by means of the non-rigid mapping;
wherein the determination of the non-rigid mapping comprises the substep:
determining a non-rigid mapping onto the object representation for at least one region of the object coordinate system to be mapped, the size of which is equal to and/or greater than the predefined minimum threshold value.

10. The computer-implemented method as claimed in claim 1, wherein the determination of the non-rigid mapping comprises the substep:
determining a deformation of the object representation by means of a simulated external mechanical force when determining the non-rigid mapping.

11. The computer-implemented method as claimed in claim 1, wherein the determination of at least one subregion of the measurement data for the analysis to be carried out by means of the nonrigid mapping comprises the substeps:
determining at least one position of a sampling point in the object coordinate system by means of the evaluation specification;
mapping the at least one determined position onto the object representation by means of the non-rigid mapping; and
determining a sampling point for the analysis of the measurement data in the object representation based on the mapped position.

12. The computer-implemented method as claimed in claim 11, wherein the determination of a sampling point in the object representation comprises the following sub-substep:
determining a change in search regions and a change in the orientation of the search regions during mapping of the object coordinate system onto the object representation.

13. The computer-implemented method as claimed in claim 1, wherein the coordinate set comprises coordinates of at least one complete sub-element of the object, wherein the determination of at least one subregion of the measurement data for the analysis to be carried out by means of the non-rigid mapping comprises the substeps:
mapping the at least one complete sub-element from the object coordinate system onto the object representation;
determining a change in the orientation of the sub-element between the object coordinate system and the object representation; and
determining sampling points based on the mapped sub-element and the changed orientation.

14. The computer-implemented method as claimed in claim 1, wherein the coordinate set comprises coordinates of at least two complete sub-elements of the object, wherein the determination of at least one subregion of the measurement data for the analysis to be carried out by means of the non-rigid mapping comprises the substeps:
mapping at least two sub-elements of the object from the object coordinate system onto the object representation;
determining a change in the orientation of the at least two sub-elements as a group between the object coordinate system and the object representation; and
determining sampling points based on the mapped sub-elements and the changed orientation.

15. A computer program product containing instructions that can be executed on a computer, which when executed on a computer cause the computer to carry out the method according to claim 1.
